(19) United States
(12) Patent Application Publication
(10) Pub. No.: US 2013/0075060 A1
(43) Pub. Date: Mar. 28, 2013

(54) ASEPTIC CONNECTION OF HEAT EXCHANGER UNITS

(71) Applicant: GE HEALTHCARE BIO-SCIENCES AB, UPPSALA (SE)

(72) Inventor: KLAUS GEBAUER, UPPSALA (SE)

(73) Assignee: GE HEALTHCARE BIO-SCIENCES AB, UPPSALA (SE)

(21) Appl. No.: 13/683,156

(22) Filed: Nov. 21, 2012

Related U.S. Application Data
(63) Continuation-in-part of application No. 13/521,242, filed on Jul. 10, 2012.

(30) Foreign Application Priority Data
Jan. 11, 2010 (SE) 1050007-2

(51) Int. Cl. F28F 9/00

(52) U.S. Cl. CPC F28F 9/00
USPC 165/72; 29/428

(57) ABSTRACT

A heat exchanger unit and a method for aseptically connecting such units. The heat exchanger unit comprises at least one fluid inlet and at least one fluid outlet. At least one of the inlet or outlet is sealed by at least one film and the contact surface between the film and the separation or reaction unit is aseptic. The films are adapted to be mated with a corresponding film on another heat exchanger unit and said mated films are adapted to be pulled out together two and two after mating such that corresponding fluid inlets/outlets on the two connected units are mated aseptically.

### FIELD OF THE INVENTION

The present invention relates to a separation or reaction unit or a heat exchanger unit, a fluid distribution unit, a separation or reaction system or a heat exchanger system and to a method for providing aseptic connections between at least two separation or reaction or heat exchanger units or at least one separation or reaction or heat exchanger unit and at least one fluid distribution unit.

### BACKGROUND OF THE INVENTION

Single use systems, also called disposable systems are more and more used in the bioprocess industry. For example separation or reaction systems such as chromatography systems, filter systems or bioreactor systems have today at least partly been provided as disposable systems. This eliminates the need for cleaning and cleaning validation before processing, in between processes and cycles or after processing before re-use as required for conventional re-usable equipment. With disposable systems cross-contamination is avoided.

Bioburden control of single-use equipment during manufacturing of the equipment itself is required to eliminate cleaning needs before bringing single-use equipment into product contact. This is usually achieved by manufacturing of single-use equipment in controlled environment (clean room), often followed by sterilisation processes (gamma irradiation). The demands of the level of bioburden control can differ for different applications, however, bioburden control to a certain degree of the equipment is not only required for some applications, but also considered as the preferable for most of the applications using disposable equipment. The production of this equipment in controlled environments is required to guarantee a low initial level of contaminants prior to the bioburden control procedure, hereby reducing for example endotoxin levels.

Sterility and asepsis are terms used to define the state of a system, a piece of equipment or a fluid conduit as being in control of bioburden levels to different degrees.

Aseptic connectors can be used to interconnect single-use equipment and also single-use equipment and conventional re-use equipment that is bioburden controlled (sanitized, sterilised etc.). Available aseptic connectors are for example ReadyMate™ connectors from GE Healthcare and Kleenpack™ from Pall.

Typical applications of aseptic connectors in biomanufacturing are connections between fluid lines, separation units (filters, chromatography columns, adsorbers, membrane adsorbers, expanded or fluidized bed adsorbers) or reaction units (bioreactors, reaction or (bio-)conversion units that for example utilize enzymatic conversions).

An example of a disposable separation system built up from a number of units is described in US2007-0241048. A problem with this system is that in order to maintain asepsis (or bioburden control) at process side when assembling the unit, assembly has to be done in a controlled environment (LAF bench).

A possible solution with today available technique is to connect each separate disposable separation or reaction unit or a unit in a heat exchanger system with aseptic connectors. However this is not cost efficient and separation efficiency is reduced due to high hold-up volume in interconnecting fluid lines.

Hereby, disposable separation or reaction systems or heat exchanger systems available today are not flexible when it comes to the capacity of the system.

### SUMMARY OF THE INVENTION

One object of the invention is to provide a more flexible separation or reaction system or heat exchanger system.

This is achieved by a method according to claim 15. Hereby a number of different heat exchanger units can be combined in an aseptic way. Hereby the customer can by himself design the heat exchanger system and provide an aseptic heat exchanger system with a wanted capacity.

This is also achieved by a heat exchanger system according to claim 13 and by a heat exchanger unit according to claim 1, and possibly also by a fluid distribution unit according to claim 7.

Suitable embodiments are described in the description and in the dependent claims.

### BRIEF DESCRIPTION OF THE DRAWINGS

FIG. 1a shows a separation unit according to one embodiment of the invention.

FIG. 1b shows a separation unit according to another embodiment of the invention.

FIGS. 2a and 2b show the two sides of a fluid distribution unit to be used together with the separation unit shown in FIG. 1a in a separation system according to one embodiment of the invention.

FIG. 3 shows a film and connection parts provided to for example a separation unit as shown in FIG. 1a or 1b or a fluid distribution unit as shown in FIGS. 2a and b.

FIG. 4a shows a separation system according to one embodiment of the invention before the system is connected. The system comprises two separation units as shown in FIG. 1a, one fluid distribution unit as shown in FIGS. 2a and b and one end plate.

FIG. 4b shows another embodiment of fluid distribution units that can be used in a separation system as shown in FIG. 4a. Here two fluid distribution units are used where one provides only the feed inlet and the other provides permeate and retentate outlets.

FIG. 4c shows the system of FIG. 4a in a first connection position where the films are released two and two together.

FIG. 4d shows the system of FIG. 4a in a second connection position (inserted into a clamp) where a fluid tight connection is provided.

FIG. 5a shows a chromatography unit for connection in series according to one embodiment of the invention.

FIG. 5b shows a chromatography unit for connection in series according to another embodiment of the invention.

FIG. 5c shows a system where units as shown in FIG. 5a or b can be connected.

FIG. 6a shows another embodiment of a chromatography unit where the distribution/collection system is provided inside each unit.

FIG. 6b shows a system where units as shown in FIG. 6a can be connected.

FIG. 7a shows a fluid distribution unit for a heat exchanger with a concurrent flow according to one embodiment of the invention.

FIG. 7b shows a fluid distribution unit for a heat exchanger with a countercurrent flow according to one embodiment of the invention.

FIG. 7c shows a heat exchanger unit according to one embodiment of the invention.

FIG. 8a shows a heat exchanger system with one fluid distribution unit for a heat exchanger in each end of the stack and two heat exchanger units in between in a first connection position where the films are released two and two together.

FIG. 8b shows the heat exchanger system of FIG. 8a in a second connection position (inserted into a clamp) where a fluid tight connection is provided.

### DETAILED DESCRIPTION OF THE EMBODIMENTS

The word aseptic used in this description and in the claims shall have a broad definition, i.e. include any level of bioburden control. The bioburden control or asepsis can be measured as organisms/ml or CFU (colony forming units). In one embodiment of the invention the level of asepsis should be below 100 CFU/ml. The latter corresponds to bioburden control levels required for food grade products. Low levels of bioburden can be achieved by sterilisation processes. For example the units of the invention can be subjected to gamma sterilization. Other possible methods are autoclaving or bioburden control by ethylene dioxide.

The present invention relates to aseptic separation or reaction or heat exchanger units that can be connected in an aseptic way. Suitably the units are disposable. The separation or reaction or heat exchanger_units can for example be filter cassettes to be provided in a filter system, chromatography units to be provided in a chromatography system or reaction units. The group of filter systems shall include at least Normal Flow Filters such as aseptic filters, particle removal filters or virus removal filters and Cross-flow filters. The group of chromatography units shall include packed bed chromatography, monoliths or other types of fixed beds but also modified membranes (membrane adsorbers) and other types of surfaces or structures that are employed for achieving a separation by means of a sorption process. The nature of the sorption process can be based on ion exchange, bio-affinity, hydrophobicity etc. and is suitably performed as a liquid based adsorption process. The group of reaction units shall include fixed bed reactors, for example for bioconversion processes, but also other configurations that rely on reactions that are at least partly run in free solution or a fluid. The group of heat exchanger units shall include preferably plate type heat exchangers, but other configurations requiring the assembly of separate heat exchanger units to build the required heat exchanger area and capacity are possible.

With this invention any desired number of separation or reaction units or heat exchanger units can be connected to each other in a system in an aseptic way. Hereby an aseptic system, for example a filter system or chromatography system, of any desired capacity can be built from units. Furthermore, these systems can be built in an environment that is not bioburden controlled and the system with all its connections will still be aseptic on process side. According to the invention a protection film is provided over the inlets/outlets of the separation or reaction units or heat exchanger units. The film is suitably provided to the units before the unit is subjected to sterilisation. This means that the separation or reaction unit with the attached film can be treated in a non sterile environment while the contents of the unit confined by its inlets/outlets including the inlets/outlets still are kept sterile or aseptic. The film is folded over the inlets/outlets and one single sheet of the film is reaching outside the unit. The film should be mated with a similar film on a connecting unit and the two films should be released together by pulling the two single sheets reaching outside the units when the units are pressed together. This ensures that the inlets/outlets on the two units will be connected in an aseptic way. Furthermore, to enable a fluid tight connection between the units at least one gasket is provided around each inlet/outlet or around a number of inlets/outlet if suitable for the device and application. A foam layer is provided around the gaskets such that the units can be pressed together to a first aseptic connection position where the protective films can be removed without exposing the aseptic process side to the environment, which may be non-sterile. The purpose of the compressible foam pads is to provide the required degree of volumetric variability to allow for an expansion of the two opposite foam pads against each other to remain asepsis when removing the adjacent folded films by pulling. This first connection position is suitably secured by a frame device or by a locking arrangement provided on each unit (further described below).

When the films have been released in this first connection position the units are pressed together even further to a second position. In the second position a fluid tight seal is provided through the gaskets having been engaged.

Suitably the separation or reaction units are disposable, i.e. adapted to be used only once. One advantage with disposable systems is that there is no need for cleaning and bioburden control before using the systems because disposable systems are already aseptic in some degree and they should not be used again and need therefore not be cleaned between uses. Therefore the aseptic connection method and means provided with this invention is particularly interesting in disposable systems. With the invention disposable systems, such as filter systems or chromatography systems or heat exchanger systems_can be built up from different units to a wanted capacity by the customer while still keeping the asepsis requirements. Below some example embodiments of the invention are given.

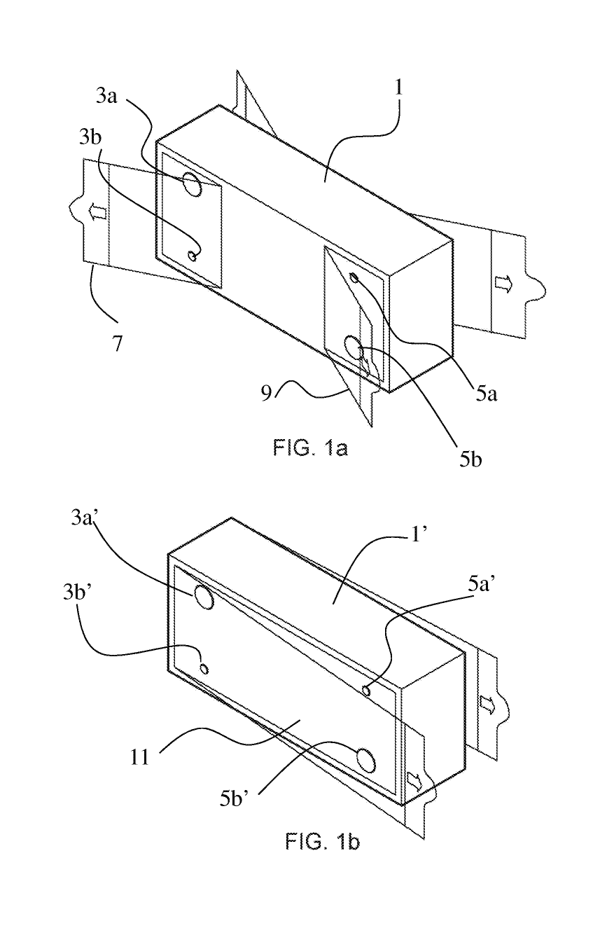

FIG. 1a shows a separation unit 1 according to one embodiment of the invention. In this embodiment the separation unit is a filter cassette 1 that is aimed for running a cross-flow filtration process. In this example the filter cassette comprises two first inlets/outlets 3a, 3b on the left side (referring to the FIG. 1a) of the filter cassette 1 and two second inlets/outlets 5a, 5b on the right side of the filter cassette 1. The number of inlet/outlets can of course vary. According to the invention a first film 7 is provided on the left side of the filter cassette covering the first inlets/outlets 3. A second film 9 is provided on the right side of the cassette covering the second inlets/outlets 5a, 5b. In FIG. 1b another embodiment of a separation unit 1′ according to the invention is shown. Here both first inlets/outlets 3a′, 3b′ on the left side of the separation unit 1′ and second inlets/outlets 5a′, 5b′ on the right side of the separation unit 1′ are covered by one single film 11. In these views only one side of the filter cassettes 1, 1′ can be seen. However, the back sides of these units are suitably designed in the same way with inlets/outlets and covering films (the films can be seen pointing out from the back sides). The surface between the films 7,9,11 and the filter cassettes 1, 1′ is aseptic. As described in the beginning of the description aseptic can mean different levels of bioburden control depending on the requirements.

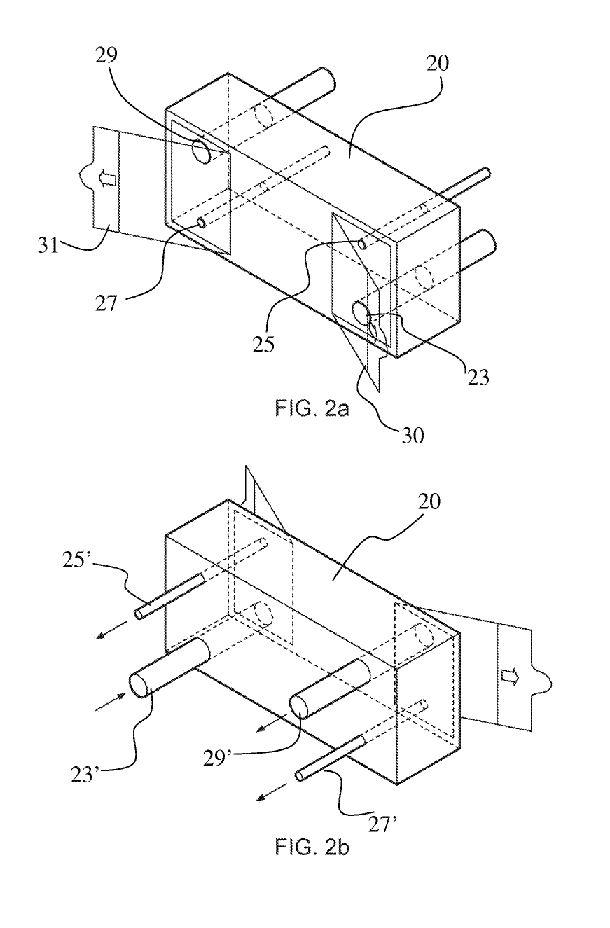

FIGS. 2a and 2b show a fluid distribution unit 20 to be used together with the separation unit 1 shown in FIG. 1a in a separation system according to one embodiment of the invention. In this embodiment the fluid distribution unit 20 is adapted to be used in a filter system and comprises on the side adapted to be connected to the filter unit (the front side in FIG. 2a) four inlet/outlets in positions that correspond with the positions of the inlet/outlets 3a,b, 5a,b. In this example a distribution unit inlet 23 is provided at the lower part on the right side (reference to FIG. 2a) of the distribution unit 20 and a first distribution unit outlet 25 (permeate-retentate) is provided above the inlet 23 and a second and a third distribution unit outlet 27, 29 are provided on the left side of the distribution unit 20. All the inlets/outlets 23, 25, 27, 29 are positioned correspondingly with the inlets/outlets 3a,b, 5,a,b of the filter unit 1 to which is adapted to connect. According to the invention the distribution unit inlets/outlets are covered by films. In this embodiment a first film 30 covers distribution unit inlet 23 and the first distribution unit outlet 25 and a second film 31 covers the second and third distribution unit outlets 27, 29. Furthermore these films 30, 31 have the same dimensions as the first and second films 7, 9 on the filter cassette to which this fluid distribution unit should be connected. As before the surface between the films and the fluid distribution unit is aseptic.

In FIG. 2b the other side of the fluid distribution unit 20 shown in FIG. 2a is shown. Here a distribution unit fluid inlet connection 23′ is shown which is connected to the distribution unit inlet 23 on the other side of the fluid distribution unit 20. Furthermore a first, second and third distribution unit fluid outlet connections 25′, 27′, 29′ are shown which all are connected to corresponding outlets on the other side of the fluid distribution unit 20.

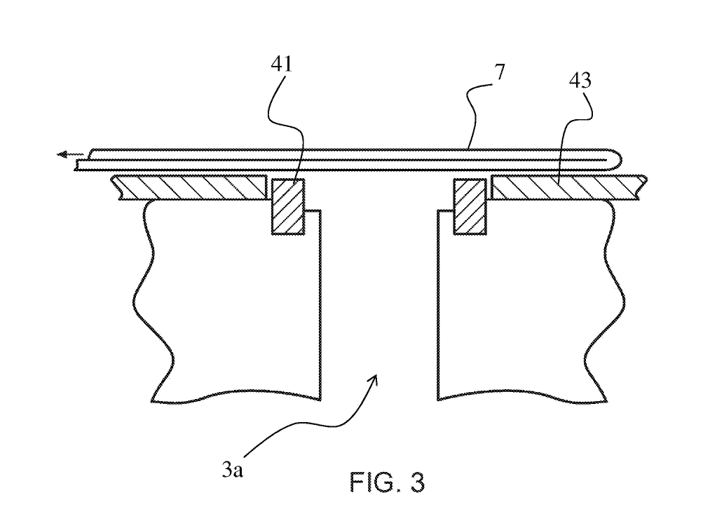

FIG. 3 shows a film and connection parts provided as aseptic barrier to for example a separation unit as shown in FIG. 1a or 1b or a fluid distribution unit as shown in FIGS. 2a and b. In FIG. 3, reference numbers corresponding to the film on the right side of FIG. 1a is used. An inlet/outlet, here the first inlet/outlet 3a in FIG. 1a is illustrated in cross section. (However all the other inlets/outlets could be illustrated similarly). Around the first inlet/outlet 3a a gasket 41 is provided. One gasket can be provided around each of the inlets/outlets on both the separation/reaction units and the fluid distribution units. In some cases it would also be possible to provide one gasket around more than one inlet/outlet. Furthermore a compressive foam layer 43 is provided around the gasket 41. The folded film 7 is provided over the first inlet/outlet 3a, the gasket 41 and the foam layer 43. The connection surface between the film 7 and the gasket 41 and the foam layer 43 is as described above aseptic.

The film 7 is folded unevenly such that the film is provided double over the separation or reaction unit or fluid distribution unit and as a single sheet of the uppermost layer is reaching outside the separation, reaction or fluid distribution unit. This part is used for being grabbed and for pulling out the film together with a matching film when the system is connected. When two separation units as shown in FIG. 1a re connected the films are mated two and two together and during connection the films are supposed to be pulled out together two and two. Hereby the aseptic surfaces of the separation units (previously covered by the films) will be mated and the asepsis will be maintained. This will be described in more detail below.

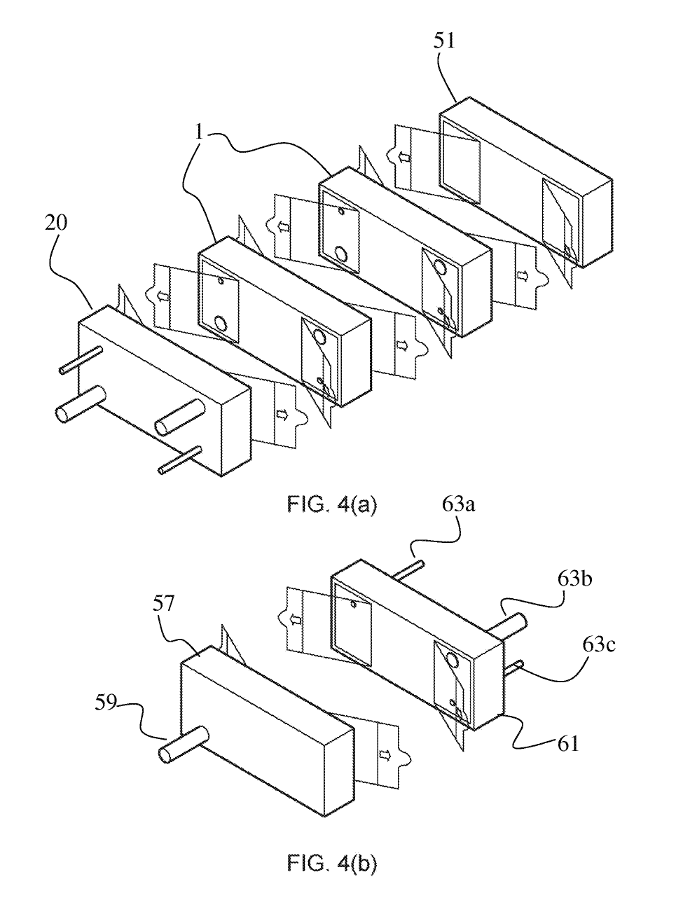

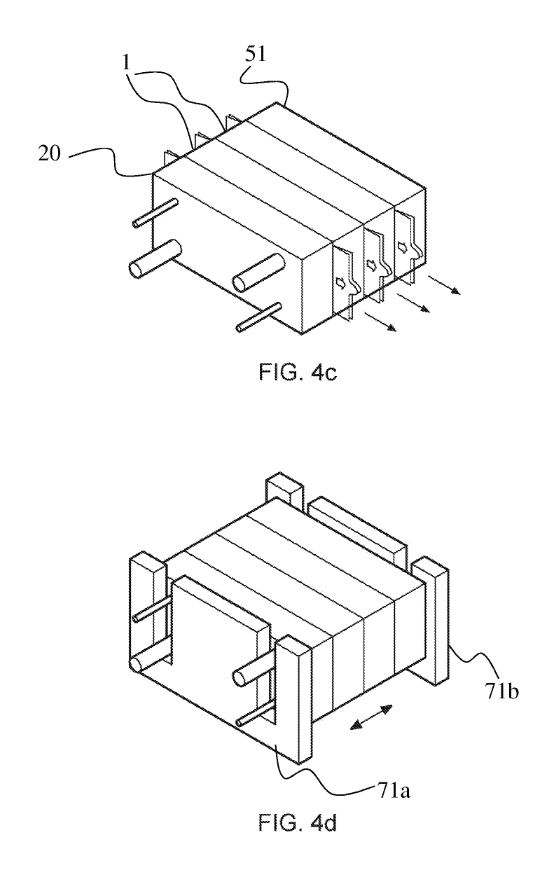

FIG. 4a shows a separation system according to one embodiment of the system before the system is connected. The system comprises two separation units 1 as shown in FIG. 1a, one fluid distribution unit 20 as shown in FIGS. 2a and 2b and one end plate 51. In this example the end plate 51 does not comprise any inlets or outlets. It is just a flat surface however provided with films to be mated with films on the closest separation unit 1. Here it can be seen how the films will be mated two and two together when the system is connected.

FIG. 4b shows another embodiment of the separation system of FIG. 4a. In this embodiment a first fluid distribution unit 57 having only one inlet connection 59 and a second fluid distribution unit 61 having three outlet connections 63a, b, c are used instead of the fluid distribution unit 20 and the end plate 51 of FIG. 4a. This will give a different type of separation system but the inventive idea with aseptic connection by the use of the films is the same.

Other configurations of end plates and distribution plates are possible. For example, the filtrate outlet (permeate) may be collected by a single outlet connection instead of using two outlet connections as shown in FIGS. 4a and 4b. Equally, other positions or orientations of fluid connections, plates and cassettes are possible.

FIG. 4c shows the system of FIG. 4a in a first connection position where the films are released in the direction of the arrows two and two together. This first connection position has been achieved by bringing the surfaces to be connected to each other together and locking the system and its units in this first position. This can for example be achieved by means of a latching arrangement where mating locking parts are provided on each connecting side of the separation or reaction units and on the fluid distribution units. This could for example be protrusions with a hook on one side of the units and recesses adapted to receive the protrusions on the other side. When pressing the protrusions into the recesses the hooks need to pass over a shoulder which will latch the hook in place.

Another alternative for achieving the first connection position is to bring the system into a clamping device applying a moderate compression force on cassettes and end units. In this first connection position the parts of the films that are reaching outside the separation units 1 and the fluid distribution unit 20 and the end unit 51 are gripped two and two together and pulled out from the system.

FIG. 4d shows the system of FIG. 4a in a second connection position where a fluid tight connection is provided. This second connection position is achieved by applying more force to the fluid distribution unit 20 and the end unit 51 in the direction towards each other, i.e. the distance between all the parts of the system will be smaller and gaskets are engaged. In this example the separation system is provided inside a compression device comprising a first compression plate 71a and a second compression plate 71b to which a compressive force can be applied in order to achieve the fluid tight seal that is needed. The compression device 71a, 71b can be locked in the compressed position such that the fluid tight seal is maintained.

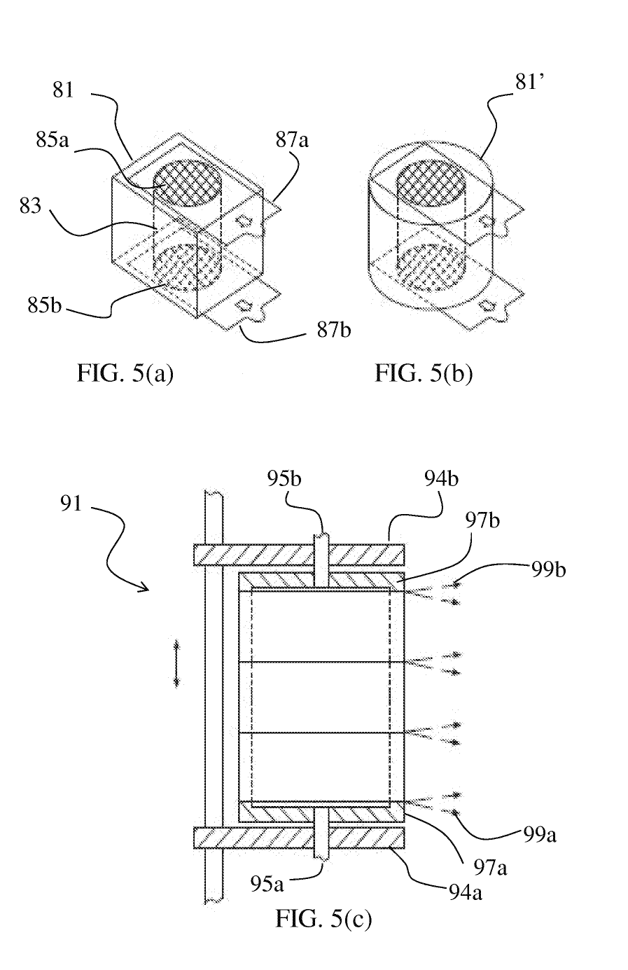

FIG. 5a shows a separation unit in the form of a chromatography unit 81 for connection in series according to one embodiment of the invention. In this embodiment the unit is provided as a cube. The chromatography unit 81 comprises a packed bed 83 with a filter 85a and 85b in each end of the packed bed 83 and facing the top and bottom of the unit respectively. These filters 85a, 85b will in this case be inlets/outlets of the unit. A protective film 87a and 87b of the same kind as described for previous embodiments of the invention is provided over each filter 85a, 85b. Hereby this chromatography unit can be connected to another chromatography unit of the same kind and the columns can be connected aseptically.

FIG. 5b shows a chromatography unit 81′ for connection in series according to another embodiment of the invention. The only difference from the chromatography unit shown in FIG. 5a is that this unit is provided as a cylinder. Other geometries of the packed bed are possible. The packed bed may be made from particles and a suspension, respectively. Instead, the porous structure of the chromatography unit may also be provided as a block, for example as chemically prepared monolith or as a sintered structure. As described before, the packed bed and units may be configured as reaction unit, for example for conducting bioconversions.

FIG. 5c shows a system 91 where units 81, 81′ as shown in FIG. 5a or b can be connected. The system comprises a compression device 93 comprising a bottom compression plate 94a and an upper compression plate 94b between which a wanted number of chromatography units 81, 81′ should be placed. The bottom compression plate 94a comprises a first inlet/outlet 95a and the upper compression plate comprises a second inlet/outlet 95b. The system 91 comprises further a first distribution plate 97a between the bottom compression plate 94a and the chromatography units to be positioned in the system. The first distribution plate 97a is further connected to the first inlet/outlet 95a and provided with a film 99a according to the invention. The film 99a is adapted to be mated with a film 87b of a chromatography unit 81, 81′ that is positioned in the lowest position of the units that should be connected. The system 91 further comprises a second distribution plate 97b positioned between the upper compression plate 94b and the units to be placed into the system. The second distribution plate 97b is connected to the second inlet/outlet 95b and provided with a film 99b according to the invention.

In FIG. 5c it is shown how three chromatography units 81, 81′ have been provided into the system 91. Also in this embodiment of the invention the units are compressed between the compression plates 94a, 94b to a first position where the mating films are released and then to a second position where a fluid tight seal is provided.

The chromatography units 81, 81′ described above in relation to FIGS. 5a, 5b and 5c could also be provided as block materials, for example as a monoliths. In this case no filters are required. The films 87a, 87b are however provided in a similar way and a similar compression device 91 as the one described in relation to FIG. 5c can be used.

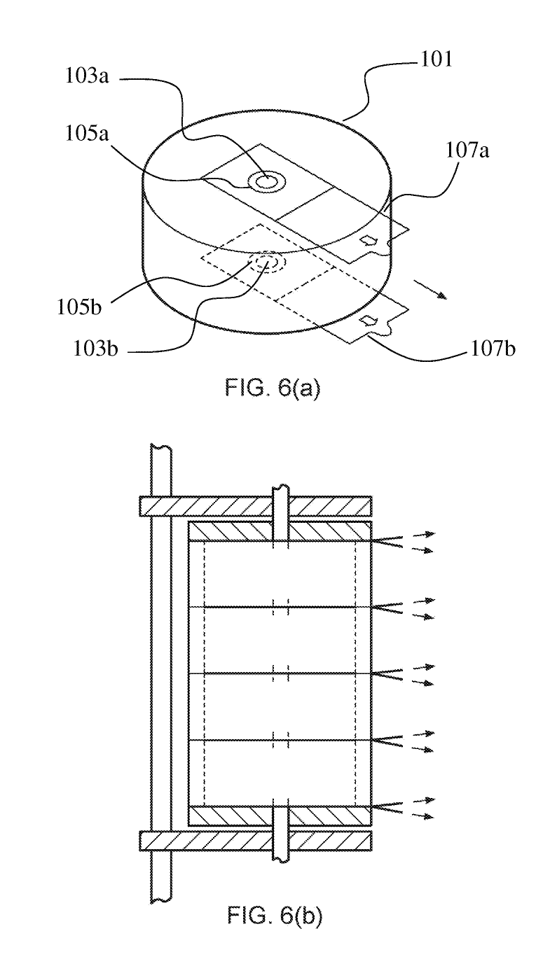

FIG. 6a shows another embodiment of a separation unit in the form of a chromatography or reaction unit 101 where the distribution/collection system is provided inside each unit. Inside the chromatography or reaction unit 101 a distribution/collection system is provided in each end of a packed bed. This is not shown. A first inlet/outlet 103a is shown in the middle of one side of the chromatography or reaction unit 101 and a second inlet/outlet 103b is shown in the middle of the other side of the chromatography or reaction unit 101. Around the inlets/outlets 103a, 103b a gasket 105a, 105b and a foam layer (not shown) is provided as also shown in FIG. 3. A film 107a, 107b according to the invention is provided over each inlet/outlet 103a, 103b.

FIG. 6b shows a system where units as shown in FIG. 6a can be connected. The system is similar to the one shown in FIG. 5c and no further description is given here. The films are mated two and two as described above and an aseptic connection is provided between the units as described above.

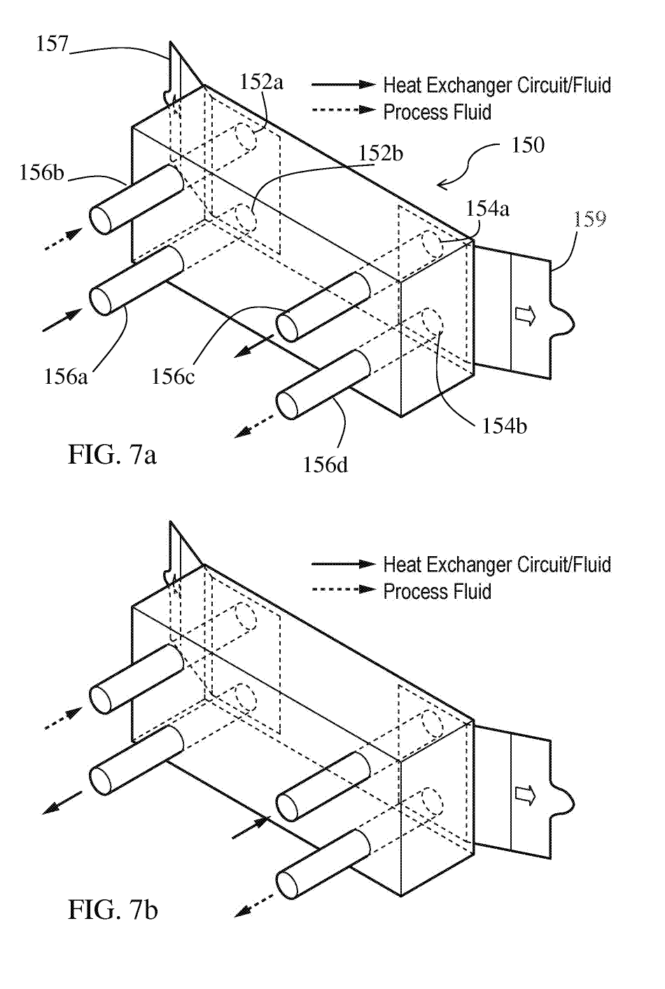

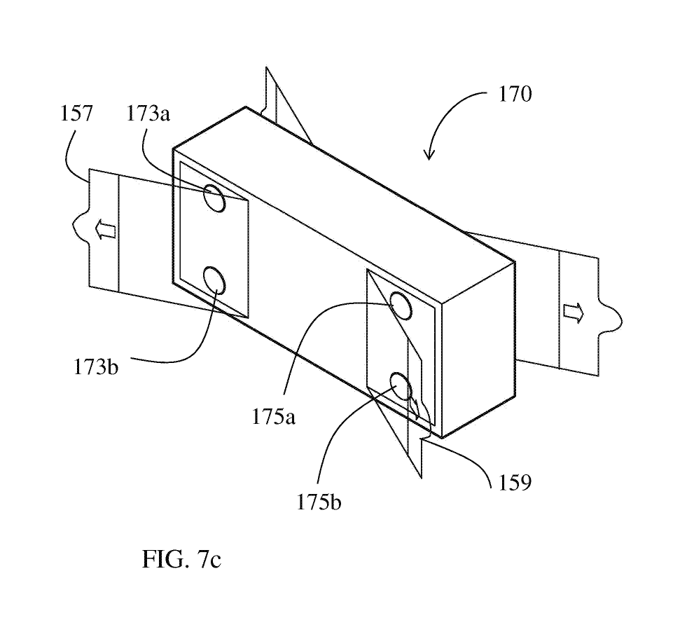

FIG. 7a shows a fluid distribution unit 150 for a heat exchanger with a concurrent flow according to one embodiment of the invention. Two first fluid distribution unit inlets/outlets 152a,b are shown on the rear side of the unit to the left in the Figure. These first inlets/outlets 152a,b are according to the invention covered by a first film 157. Two second fluid distribution unit inlets/outlets 154a,b are shown on the rear side of the unit to the right in the Figure. These second inlets/outlets are according to the invention covered by a second film 159. The films are not described further here but are the same as described above in relation to the other embodiments and they are provided for aseptic connection of two or more units. On the front side of the heat exchanger unit four connectors 156a,b,c,d are shown. In this embodiment a first connector 156a is provided on the left side of the unit and is used as inlet for heat exchanger circuit/fluid. A second connector 156b is provided above the first connector on the left side and is used as inlet for process fluid. A third connector 156c is provided on the right side of the unit and is used as outlet for the heat exchanger circuit/fluid and a fourth connector 156d is provided below the third connector 156c on the right side of the unit and is used as outlet for the process fluid. The first, second, third and fourth connectors are connected through the unit to respective inlets/outlets 152a,b, 154a,b on the rear side of the unit. Said fluid distribution unit 150 for a heat exchanger is to be connected with heat exchanger units as shown in FIG. 7c to form a heat exchanger system in a corresponding manner as outlined in FIG. 4 for the separation modules.

FIG. 7b shows a heat exchanger unit with a countercurrent flow according to another embodiment of the invention. The difference from FIG. 7a is only the use of the connectors for inlet and outlet for heat exchanger fluid and process fluid respectively. This is illustrated by the arrows in the Figure.

FIG. 7c shows a heat exchanger unit 170 according to one embodiment of the invention that can be aseptically connected to other heat exchanger units 170 and to heat exchanger fluid distribution units 150 as showed in FIGS. 7a and 7b. This heat exchanger unit 170 comprises two first inlets/outlets 173a, 173b on the left side (referring to FIG. 7c) and two second inlets/outlets 175a, 175b on the right side. A first film 157 is provided covering the first inlets/outlets and 173a, 173b a second film 159 is provided covering the second inlets/outlets 175a, 175b. This is similar to what is shown in FIG. 1a. The films are also the same and will not be further described here. The back side of the heat exchanger unit is suitably designed in the same way with inlets/outlets and covering films.

The seizes of the connectors and inlets/outlets are here shown to be equal in contrast to for example FIGS. 1 and 2. However these seizes can be varied. When a heat exchanger fluid distribution unit according to FIG. 7a or 7b should be connected with heat exchanger units into a heat exchanger system in the same as shown in for example FIG. 4 one or more heat exchanger units are provided between the heat exchanger fluid distribution unit 150 shown in FIG. 7a or 7b and one end plate. The end plate is similar to the end plate 51 shown in FIG. 4. The fluid distribution unit 150 for a heat exchanger, the one or more heat exchanger units 170 and the end plate (similar to 51 in FIG. 4a) are put together in the same way as shown in FIG. 4c. This is a first connection position where the films are released. The system can be locked in this position in the same way as described in relation to FIG. 4c. Then a second connection position is achieved in the same way as described in relation to FIG. 4d. The heat exchanger system is provided inside a compression device (71a, 71b in FIG. 4d). The heat exchanger system is compressed such that a fluid tight connection is provided.

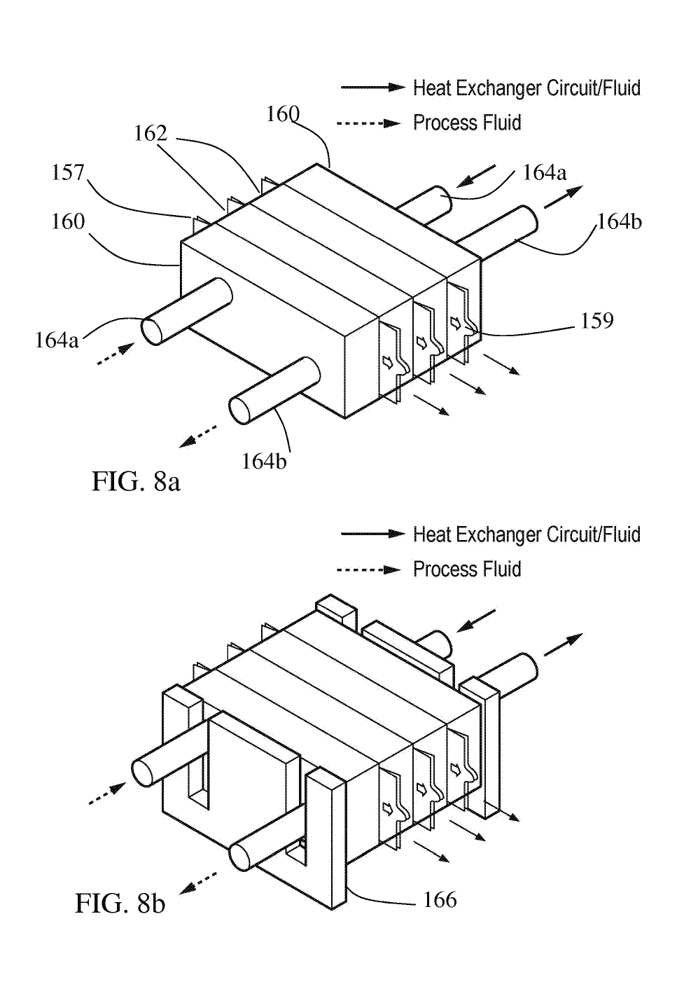

FIG. 8a shows another embodiment of a heat exchanger system according to the invention. This heat exchanger system comprises one fluid distribution unit 160 for a heat exchanger outermost in each end of the stack and two (or more) heat exchanger units 162 in between. The heat exchanger system is here in a first connection position where the films 157, 159 are released two and two together to provide an aseptic connection. The fluid distribution units 160 shown here only have one inlet connector 164a and one outlet connector 164b each and one of the fluid distribution units is used for heat exchanger circuit/fluid and the other is used for process fluid. The heat exchanger units 162 are similar to the units shown in FIG. 7c. The number of heat exchanger units 162 could of course be varied.

FIG. 8b shows the heat exchanger system of FIG. 8a in a second connection position (inserted into a clamp/compressing device 166) where a fluid tight connection is provided.

FIGS. 7 and 8 show heat exchanger systems built by aseptically connecting separate heat exchanger units in a plate and frame fashion. Each heat exchanger unit has at least one, but preferably a multitude of parallel flow channels for process fluid and heat exchanger fluid, both (at least one) fluid channels being adjacent to each other but separated by an impermeable wall that prevents any fluid exchange between the fluid systems. The impermeable wall is selected from a material with sufficient heat conductance properties. Preferably, turbulence enhancing spacers are positioned in each fluid channel inside the heat exchanger module to enhance heat transfer properties of the system. Suitably, all materials of construction are selected from plastic/polymeric materials that allow efficient disposal of the units after use, preferably by incineration.

The turbulence enhancing spacers in the fluid channels are preferably selected from polymeric meshes that can be pressed or woven. The latter may also provide mechanical and dimensional stability to define the channel thickness. Alternatively, the walls of the fluid channels may be corrugated to enhance heat transfer and provide the channel thickness.

The connections to the heat exchanger system may be configured for providing a concurrent or a countercurrent flow in the heat exchanger system. See FIGS. 7a and 7b. In one embodiment, the heat exchanger fluid is provided pre-sterilized to further avoid the risk of cross-contamination in case of integrity failure. In a further embodiment, the heat exchanger fluid is provided from pre-sterilized or sterile filtered ultra-pure water such as Water for Injection (WFI).

FIGS. 8a and 8b shows an alternative and spatially separated connection of process and heat exchanger at each side of the heat exchanger system. This arrangement has the advantage that the overall efficiency may be increased as the pressure loss inside and variation of local flow rates inside the heat exchanger system is compensated for. The arrangement may also preferable for ease of use and process safety as process fluid connections and heat exchanger fluid connections are clearly separated from each other.

In one embodiment of the disposable heat exchanger system, temperature sensors allowing for improved process control are positioned in the connection plates and/or the heat exchanger units. In another embodiment, pressure sensors are positioned in the connection plates and/or the heat exchanger units.

The gaskets and foam layers described in relation to FIG. 3 could as well be used for the heat exchanger system described in relation to FIGS. 7 and 8.

In all these embodiments described above the parts and surfaces being in contact with a process fluid are suitably selected from materials that are in accordance with typical material requirements in (bio-)pharmaceutical manufacturing or food grade quality. For example, materials are suitably in compliance with USP Class VI and 21 CFR 177. Furthermore they are suitably of animal-free origin and compliance to EMEA/410/01.

What is claimed is:

1. A heat exchanger unit (170; 162) comprising at least one fluid inlet (173a,b, 175a,b) and at least one fluid outlet (173a,b, 175a,b), wherein
at least one of said at least one fluid inlet and at least one fluid outlet is sealed by at least one film (157, 159) and the contact surface between the film and the heat exchanger unit is aseptic; and in that
said at least one film is adapted to be mated with a corresponding film on another heat exchanger unit and said mated films are adapted to be pulled out together two and two after mating such that corresponding fluid inlets/outlets on the two connected units are mated aseptically.

2. The heat exchanger unit of claim 1, wherein it is a disposable unit.

3. The heat exchanger unit of claim 1, wherein parts and surfaces in contact with a process fluid are aseptic.

4. The heat exchanger unit of claim 1, further comprising one gasket (41; 105a, 105b) around each inlet/outlet or possibly one gasket around a suitable number of inlets/outlets, said gasket being adapted to mate with a corresponding gasket or surface on another heat exchanger unit when the films (157, 159) have been released two and two.

5. The heat exchanger unit of claim 4, further comprising a foam layer (43) around each gasket (41; 105a, 105b) adapted to be compressed around each gasket when two units are mated.

6. The heat exchanger unit of claim 1, wherein said films (157, 159) are double folded over said inlets/outlets and a single sheet of the uppermost layer of the film is reaching outside the unit and adapted to be pulled together with another single sheet of another film when the films are released from a connected system.

7. A heat exchanger fluid distribution unit (150; 160) adapted to be used together with the heat exchanger unit (170; 162) of claim 1, comprising on the side adapted to be connected to the heat exchanger unit at least one fluid distribution unit inlet/outlet (152a,b,c,d), wherein
said fluid distribution unit inlets/outlets (152a,b,c,d) are covered by at least one film (157,159), whereby the contact surface between the film and the surface of the heat exchanger fluid distribution unit is aseptic; and in that
said at least one film (157,159) is adapted to be mated with a corresponding film (157,159) on a heat exchanger unit (170; 162) which the heat exchanger fluid distribution unit should be connected with and said films are adapted to be pulled out together two and two after mating such that corresponding fluid inlets/outlets on the two connected units are mated aseptically.

8. The heat exchanger fluid distribution unit of claim 7, wherein it is a disposable unit.

9. The heat exchanger fluid distribution unit of claim 7, wherein parts and surfaces in contact with a process fluid are aseptic.

10. The heat exchanger fluid distribution unit of claim 7, further comprising one gasket around each inlet/outlet or possibly one gasket around a suitable number of inlets/outlets, said gasket being adapted to mate with a corresponding gasket on a separation unit which the fluid distribution unit should be connected with when the films have been released two and two.

11. The heat exchanger fluid distribution unit of claim 10, further comprising a foam layer around each gasket adapted to be compressed around each gasket when two units are mated.

12. The heat exchanger fluid distribution unit of claim 7, wherein said films are double folded over said inlets/outlets and a single sheet of the uppermost layer of the film is reaching outside the unit and adapted to be pulled together with another single sheet of another film when the films are released from a connected system.

13. A heat exchanger system adapted to hold at least two heat exchanger units (170; 162) comprising at least one fluid inlet (173a,b, 175a,b) and at least one fluid outlet (173a,b, 175a,b), wherein
at least one of said at least one fluid inlet and at least one fluid outlet is sealed by at least one film (157, 159) and the contact surface between the film and the heat exchanger unit is aseptic; and in that
said at least one film is adapted to be mated with a corresponding film on another heat exchanger unit and said mated films are adapted to be pulled out together two and two after mating such that corresponding fluid inlets/outlets on the two connected units are mated aseptically, or said heat exchanger system is adapted to hold at least one such heat exchanger unit (170; 162) between two heat exchanger fluid distribution units (150; 160) of claim 7 or between one such heat exchanger fluid distribution unit (150; 160) and one end plate (51), the system further comprises a compressing device (71a, 71b; 166) for forcing the heat exchanger units and possibly the heat exchanger fluid distribution units towards each other to a second position after the films have been released where a fluid tight seal is provided.

14. The heat exchanger system of claim 13, wherein the compressing device (71a, 71b; 166) further is adapted to force the heat exchanger units (170; 162) and possibly the heat exchanger fluid distribution units (150; 160) to a first position where the films are released two and two together hereby connecting the internal volumes of the heat exchanger units without exposing the internal volumes of the heat exchanger units to the ambient atmosphere before applying more force and forcing the heat exchanger units and possibly the heat exchanger fluid distribution units to the second position where a fluid tight seal is provided.

15. A method for providing aseptic connections between at least two heat exchanger units (170; 162) comprising at least one fluid inlet (173a,b, 175a,b) and at least one fluid outlet (173a,b, 175a,b), wherein
at least one of said at least one fluid inlet and at least one fluid outlet is sealed by at least one film (157, 159) and the contact surface between the film and the heat exchanger unit is aseptic; and in that
said at least one film is adapted to be mated with a corresponding film on another heat exchanger unit and said mated films are adapted to be pulled out together two and two after mating such that corresponding fluid inlets/outlets on the two connected units are mated aseptically,
or providing aseptic connections between at least one such heat exchanger unit and at least one heat exchanger fluid distribution unit (150; 160) of claim 7, comprising:
positioning at least one such heat exchanger unit in an optional order possibly between two such heat exchanger fluid distribution units or between one such heat exchanger fluid distribution unit (150) and one end plate (51), hereby the films (157, 159) covering the fluid inlets/outlets on the heat exchanger units and possibly the heat exchanger fluid distribution units and end plate will be mated two and two;
applying a first compression force between the first and last heat exchanger units or possibly between the heat exchanger fluid distribution units or between the heat exchanger fluid distribution unit and the end plate to force the units towards each other to a first position;
releasing the films two and two together; and
applying a second compression force between the first and last heat exchanger units or possibly between the heat exchanger fluid distribution units or between the heat exchanger fluid distribution unit and the end plate to force the units towards each other to a second position where a fluid tight seal is provided.

16. The method of claim 15, further comprising securing the heat exchanger system in a compressed state.
